(19) United States
(12) Patent Application Publication
(10) Pub. No.: US 2005/0083620 A1
(43) Pub. Date: Apr. 21, 2005

(54) ESD PROTECTION CIRCUIT WITH A STACK-COUPLING DEVICE

(76) Inventors: Yung-Hao Lin, Miao- Li Hsien (TW); Tay-Her Tsaur, Tai-Nan City (TW); Ta-Hsun Yeh, Hsin-Chu City (TW); Chao-Cheng Lee, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,093

(22) Filed: Jun. 18, 2004

(30) Foreign Application Priority Data
Oct. 15, 2003 (TW) 092128616

(51) Int. Cl. H02H 9/00

(52) U.S. Cl. 361/56

(57) ABSTRACT

An ESD protection circuit installed among a plurality of reference nodes includes a clamping device coupled between two reference nodes among the plurality of reference nodes; a stack-coupling device coupled between the clamping device and one of the reference nodes; and at least a resistive device coupled between the stack-coupling device and another one of the reference nodes.

### BACKGROUND OF INVENTION

1. Field of the Invention

The invention relates to an ESD protection circuit, and more particularly, to an ESD protection circuit installed with a stack-coupling device.

2. Description of the Prior Art

Electrical charges caused by electrostatic discharge (ESD) effects may destroy internal circuitry of an integrated circuit. In order to solve the problem caused by the ESD effect, an ESD protection circuit is set to couple with at least an I/O port and a voltage source (VDD/VSS). When the ESD effect occurs, the ESD protection circuit has to provide a low-resistance discharge path so that the ESD pulses with extremely high peak values can be discharged through the low-resistance discharge path without destroying the internal circuitry. In addition, when the circuit normally operates, the ESD protection circuit should not affect operations of the circuit.

MOS transistors are generally and widely used in ESD protection circuits, and the induced snap-back effect of the MOS transistors can supply a low-resistance static discharge path. Please refer to FIG. 1, which is a schematic diagram of a conventional ESD protection circuit 10. The ESD protection circuit 10 is implemented with a MOS transistor MC, and the transistor MC can be regarded as a clamping transistor. The drain of the transistor MC is coupled to an internal circuit 14, and a parasitic diode is formed at the transistor MC. When any ESD pulse is transmitted to the ESD protection circuit 10 and induces static currents, the generated static current will be immediately discharged by the parasitic diode and the snap-back effect of the transistor MC. However, the snap-back effect in the transistor MC has to be triggered by a p-n junction breakdown, and a corresponding trigger voltage may be high enough to cause damage. Nowadays, a (gate) coupling effect can be utilized by connecting the gate of the transistor MC to the voltage source (VDD or VSS) through a resistive device or another transistor in order to significantly reduce the trigger voltage required for the snap-back effect. In the meantime, in order to ensure the occurrence of the snap-back effect, a gate (coupling) voltage of the transistor MC (the clamping device) should be kept for a certain period of time; that is, before the snap-back effect occurs, the gate voltage of the transistor MC shown in FIG. 1 should be maintained at a specific value.

In addition, please refer to FIG. 2. A resistor-capacitor (RC) combination can co-operate with a MOS transistor to delay a decay rate of the gate coupling voltage of the clamping device. However, when the prior-technique utilizes the structure shown in FIG. 2 to provide delay effect, the resistor R and the capacitor C installed in the circuit lack flexibility and the RC combination brings excessive circuit area to increase the cost.

### SUMMARY OF INVENTION

It is therefore one of the objects of the claimed invention to provide an ESD protection circuit installed with a stack-coupling device to enhance ESD-preventing ability and to solve the above-mentioned problems.

According to the claimed invention, a stack-coupling device is installed in the ESD protection circuit to improve the ESD-preventing ability of the ESD protection circuit. An OFF duration of the coupling transistor can be adjusted by the stack-coupling device. Moreover, a composite discharging resistance of the stack-coupling device can also be properly arranged.

In the ESD protection circuit according to the embodiments of the present invention, we utilize a stack-structure coupling device to control the gate voltage of a clamping device to optimize the ESD-preventing ability. In the stack-coupling device, at least two coupling transistors are installed in order to achieve an appropriate OFF duration of the coupling transistors. In addition, regarding the conducted coupling transistors in series connection, an appropriate composite discharging resistance can be achieved to acquire optimized coupling-voltage variation curve and to increase the flexibility of the ESD protection circuit. Since the stack-coupling device has larger composite discharging resistance, under the same coupling-voltage variation curve, the stack-coupling device of the present invention can save more circuit area that that according to the prior art.

These and other objects of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of an embodiment of a conventional ESD protection circuit.

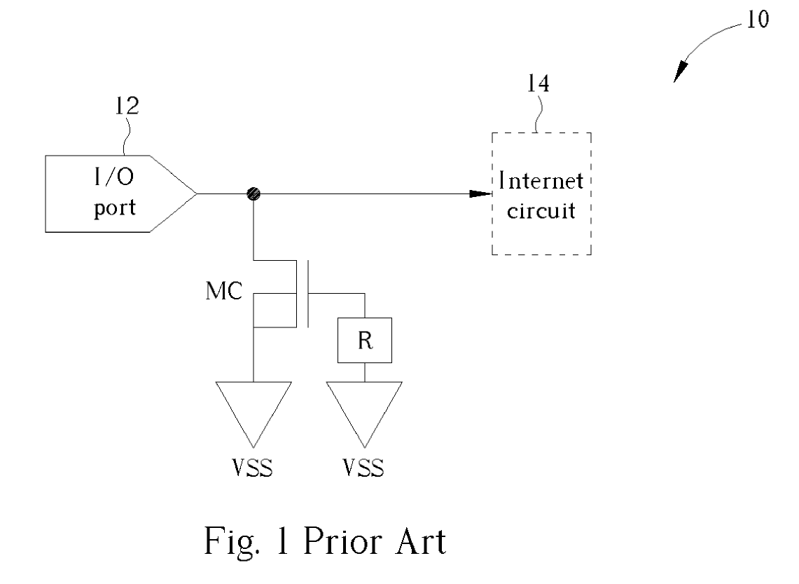

FIG. 2 is a schematic diagram of another embodiment of a conventional ESD protection circuit.

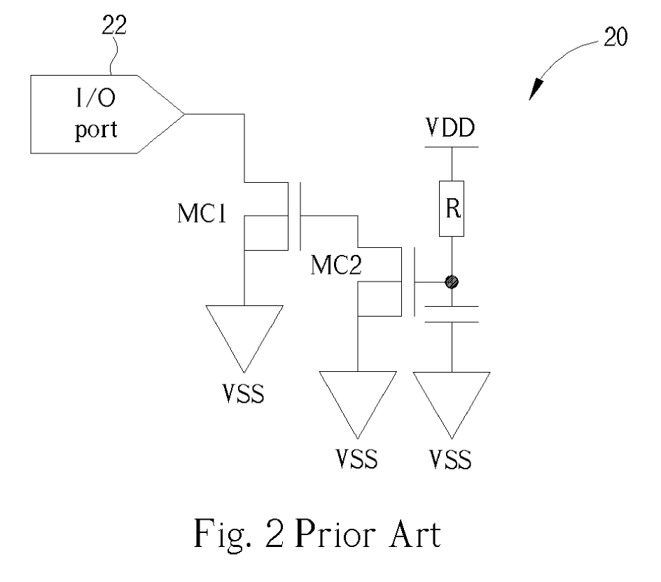

FIG. 3 is a schematic diagram of a first embodiment of an ESD protection circuit of the present invention.

FIG. 4 is a schematic diagram showing variation curves of the gate voltages of clamping devices of various ESD protection circuits.

FIG. 5 is a schematic diagram of a second embodiment of an ESD protection circuit of to the present invention

FIG. 6 is a schematic diagram of a third embodiment of an ESD protection circuit of the present invention.

FIG. 7 is a schematic diagram of an ESD preventing system according to the embodiment of the present invention.

### DETAILED DESCRIPTION

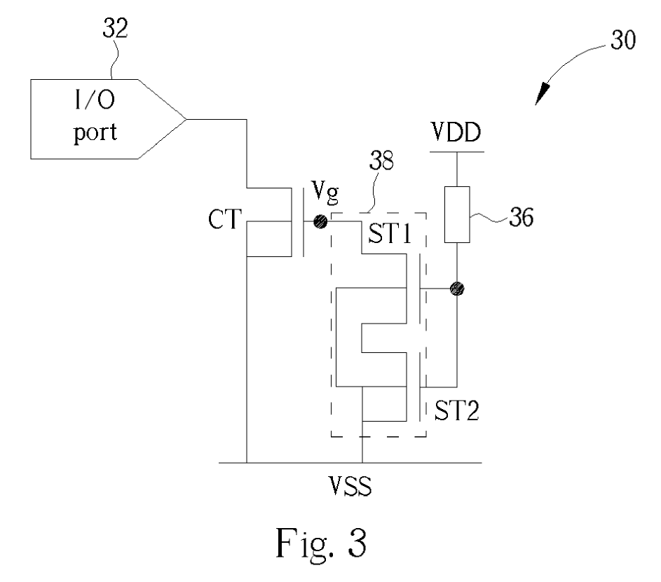

Embodiments related to the ESD protection circuits according to the present invention include various types. The ESD protection circuits of various types are respectively installed among an I/O port, a high-level voltage source VDD, and a grounding voltage source VSS in a circuit system. Those ESD protection circuits have similar internal structures. Please refer to FIG. 3, which is a schematic diagram of a first embodiment of an ESD protection circuit 30 of the present invention. The ESD protection circuit 30 is installed between an I/O port 32 and a grounding voltage source VSS. The ESD protection circuit 30 includes a clamping transistor CT, a first coupling transistor ST1, a second coupling transistor ST2, and a resistive device 36. In the present embodiment, the clamping transistor CT, the first coupling transistor ST1, and the second coupling transistor ST2 are respectively implemented with a MOS transistor, including a PMOS or an NMOS transistor. The source and the drain of the clamping transistor CT are respectively coupled to the I/O port 32 and the grounding voltage source VSS to provide a low-resistance basic static discharge path. The first coupling transistor ST1 and the second coupling transistor ST2, which are coupled to each other in series connection, can be combined to be regarded as a stack-coupling device 38. The gate of the clamping transistor CT is coupled to the first coupling transistor ST1 while the source or the drain of the second coupling transistor ST2 is coupled to the grounding voltage source VSS. In addition, the gates of both the first coupling transistor ST1 and the second coupling transistor ST2 are coupled to the resistive device 36. Via the resistive device 36, the gates of both the first coupling transistor ST1 and the second coupling transistor ST2 are coupled to the high-level voltage source VDD. When being practically implemented, the resistive device 36 can be a resistor, a shallow junction structure, a well structure, a poly-silicon device, or a MOS transistor.

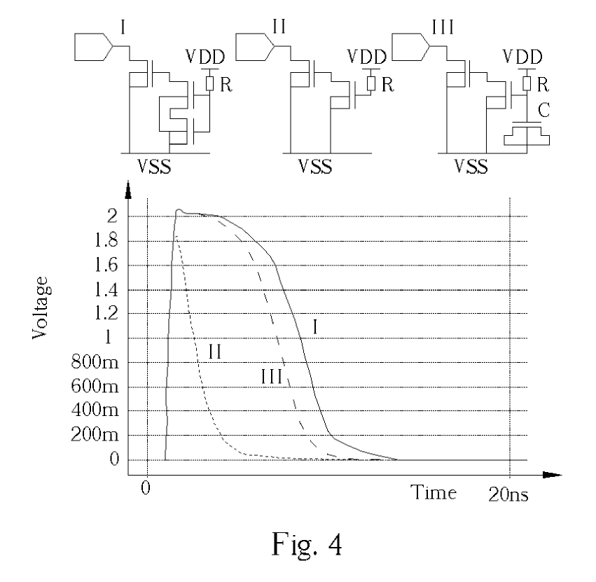

In the present embodiment, the first coupling transistor ST1 and the second coupling transistor ST2 can be respectively designed to be a stack coupling device 38 to acquire the appropriate OFF duration and composite discharging resistance of the coupling transistors. For instance, the first coupling transistor ST1 can be used to preliminarily adjust the discharging resistance while the second coupling transistor ST2 can be combined with the first coupling transistor ST1 to control the OFF duration of the coupling transistors by the generated resistor-capacitor (RC) delay effect according to the capacitance characteristics of the gate. Moreover, the composite discharging resistance of the stack coupling transistors can be further adjusted to acquire an appropriate coupling-voltage variation curve. Please refer to FIG. 4, which is a schematic diagram showing variation curves related to the gate voltages of the clamping devices in various ESD protection circuits. The vertical axis shows the variation of the gate coupling voltage Vg of the clamping transistor, and the horizontal axis represents the time dimension. As shown in FIG. 4, the stack-coupling device 38 can be utilized to keep the gate voltage Vg of the clamping transistor CT, to delay the decay rate, and to sufficiently provide the trigger voltage required for the snap-back effect. After the snap-back effect triggers, the gate coupling voltage Vg of the clamping transistor CT can be quickly discharged since the first coupling transistor ST1 and the second coupling transistor ST2 are conducted so that an effective discharging resistance is immediately decreased. Therefore, the reliability of the clamping transistor CT can be increased and related leakage current can be prevented. In addition, the ESD protection circuit 30 of the embodiment of the present invention can make use of the stack-coupling device 38 to appropriately adjust the W/L ratio and area of each coupling transistor so as to determine the most suitable OFF duration and composite discharging resistance for the coupling transistors.

Please notice that, in the stack-coupling device 38 according to the embodiment of the present embodiment, the amount of the coupling transistors is not constrained; that is, the stack-coupling device 38 can be implemented with more than two coupling transistors.

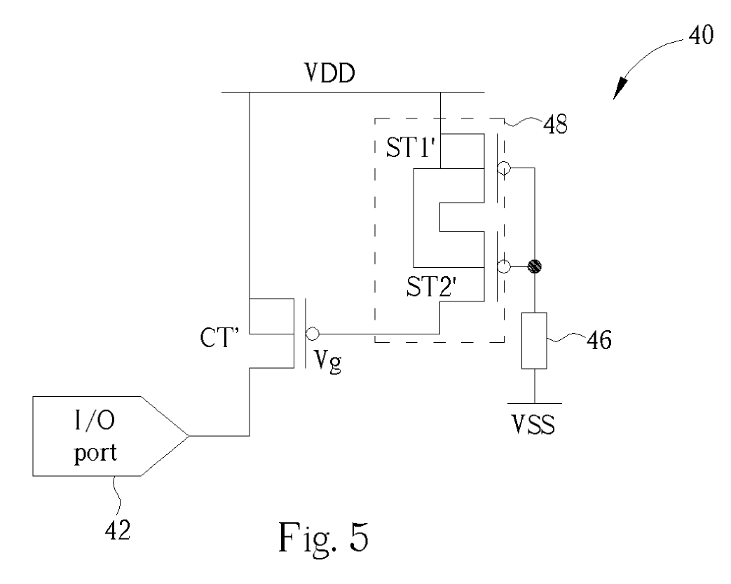

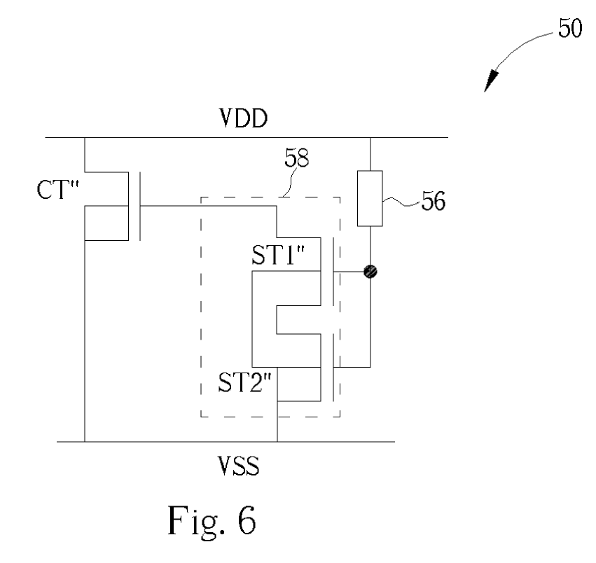

A second embodiment of the ESD protection circuit of the present invention refers to FIG. 5, which inherits the structure and characteristics of the embodiment shown in FIG. 3. The ESD protection circuit shown in FIG. 5 is installed between the high-level voltage source VDD and the I/O port 42. Another similar structure please refers to FIG. 6, which is a schematic diagram of a third embodiment of the ESD protection circuit 50. The ESD protection circuit 50 in the third embodiment is installed between the high-level voltage source VDD and the grounding voltage source VSS.

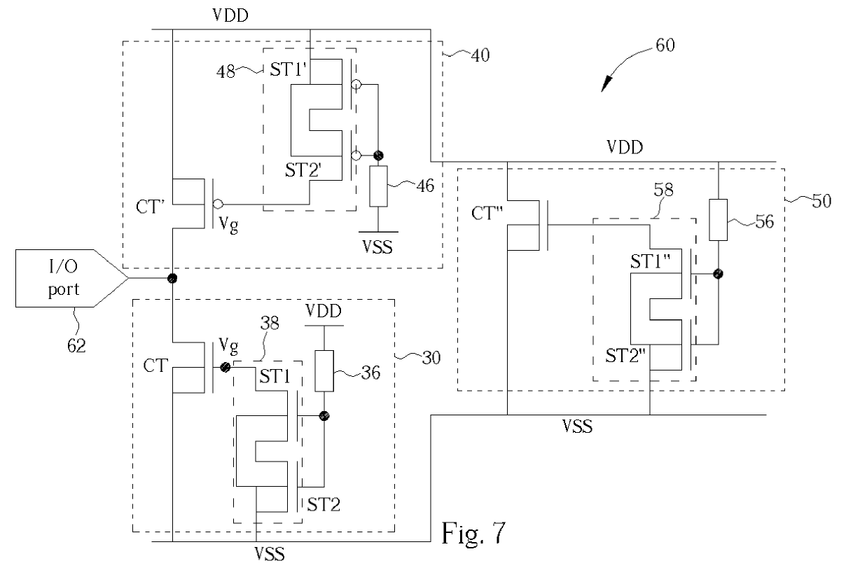

In an ESD protection system, the above-mentioned ESD protection circuits of three types (respectively shown in FIG. 3, FIG. 5, and FIG. 6) can be integrated among an I/O port, a high-level voltage source VDD, and a grounding voltage source VSS in an integrated circuit system to provide a complete ESD-preventing ability. Please refer to FIG. 7, which is a schematic diagram of an ESD preventing system 60 of the present invention.

Actually, the ESD protection circuit disclosed in the embodiments of the present invention may be installed with the stack-coupling device to control the gate voltage of the clamping transistor through utilizing the stack-coupling device so that the snap-back effect can be enhanced. In addition, Through utilizing the stack-coupling device, the ESD protection circuit disclosed in the embodiments of the present invention can flexibly determine the appropriate OFF duration and composite discharging resistance for the coupling transistors so as to acquire an optimized coupling-voltage variation curve and a better ESD-preventing ability.

1. An ESD (electrostatic discharge) protection circuit installed with an integrated circuit (IC) comprising a plurality of reference nodes for preventing an electrostatic discharge (ESD) effect, the ESD protection circuit comprising:
a clamping device coupled between two reference nodes of the reference nodes;
a stack-coupling device coupled to the clamping device and one of the reference nodes; and
at least a resistive device coupled to the stack-coupling device and another one of the reference nodes.

2. The ESD protection circuit of claim 1 wherein the stack-coupling device comprises a plurality of MOS transistors coupled to each other in series connection.

3. The ESD protection circuit of claim 1 wherein the clamping device is a MOS transistor.

4. The ESD protection circuit of claim 3 wherein the stack-coupling device is for controlling a gate voltage of the MOS transistor.

5. The ESD protection circuit of claim 1 wherein an OFF duration of the stack-coupling device can be adjusted by adjusting the stack-coupling device.

6. The ESD protection circuit of claim 1 wherein a composite discharging resistance of the stack-coupling device can be adjusted by adjusting the stack-coupling device.

7. The ESD protection circuit of claim 3 wherein the reference nodes comprise a first voltage source and a second voltage source; the clamping device is coupled between the first voltage source and the second voltage source; the stack-coupling device is coupled between the clamping device and the second voltage source; and the resistive device is coupled between the stack-coupling device and the first voltage source.

8. The ESD protection circuit of claim 3 wherein the reference nodes comprise an I/O port, a first voltage source, and a second voltage source; the clamping device is coupled between the I/O port and the second voltage source; the stack-coupling device is coupled between the clamping device and the second voltage source; and the resistive device is coupled between the stack-coupling device and the first voltage source.

9. The ESD protection circuit of claim 3 wherein the reference nodes comprise an I/O port, a first voltage source, and a second voltage source; the clamping device is coupled between the I/O port and the first voltage source; the stack-coupling device is coupled between the clamping device and the first voltage source; and the resistive device is coupled between the stack-coupling device and the second voltage source.

10. The ESD protection circuit of claim 1 wherein the resistive device is a resistor, a shallow junction structure, a well structure, a poly-silicon device, a MOS transistor, or a random combination of the above-mentioned embodiments.

11. An ESD protection circuit for preventing an ESD effect installed among an I/O port, a first voltage source, and a second voltage source comprising:
a clamping device coupled between the I/O port and the first voltage source;
a stack-coupling device coupled between the clamping device and the first voltage source; and
a resistive device coupled between the stack-coupling device and the second voltage source.

12. The ESD protection circuit of claim 11 wherein the stack-coupling device comprises a plurality of MOS transistors coupled to each other in series connection.

13. The ESD protection circuit of claim 11 wherein the clamping device is a MOS transistor.

14. The ESD protection circuit of claim 13 wherein the stack-coupling device is used to control a gate voltage of the MOS transistor.

15. The ESD protection circuit of claim 11 wherein an OFF duration of the stack-coupling device can be adjusted by adjusting the stack-coupling device.

16. The ESD protection circuit of claim 11 wherein a composite discharging resistance of the stack-coupling device can be adjusted by adjusting the stack-coupling device.

17. The ESD protection circuit of claim 11 wherein the resistive device is a resistor, a shallow junction structure, a well structure, a poly-silicon device, a MOS transistor, or a random combination of the above-mentioned embodiments.

18. An ESD protection circuit for preventing an ESD effect installed between a first voltage source and a second voltage source, the protection circuit comprising:
a clamping device coupled between the first voltage source and the second voltage source;
a stack-coupling device coupled between a gate of the clamping device and the second voltage source; and
a resistive device coupled between the stack-coupling device and the first voltage source.

19. The ESD protection circuit of claim 18 wherein the stack-coupling device comprises a plurality of MOS transistors coupled to each other in series connection.

20. The ESD protection circuit of claim 18 wherein the clamping device is a MOS transistor.

21. The ESD protection circuit of claim 20 wherein the stack-coupling device is used to control a gate voltage of the MOS transistor.

22. The ESD protection circuit of claim 18 wherein an OFF duration of the stack-coupling device can be adjusted by adjusting the stack-coupling device.

23. The ESD protection circuit of claim 18 wherein a composite discharging resistance of the stack-coupling device can be adjusted by adjusting the stack-coupling device.

24. The ESD protection circuit of claim 18 wherein the resistive device is a resistor, a shallow junction structure, a well structure, a poly-silicon device, a MOS transistor, or a random combination of the above-mentioned embodiments.
